(19) United States
(12) Patent Application Publication
(10) Pub. No.: US 2014/0059117 A1
(43) Pub. Date: Feb. 27, 2014

(54) SERVICE PROVIDER FACILITATING ACCESS OF DIVERSE WEB-BASED SERVICES

(71) Applicants: Anoop Santhanam, Bnagalore (IN); Chandramouli Vishwadutta Jamadagni, Bnagalore (IN); Sankarshana Seshagiri, Bangalore (IN)

(72) Inventors: Anoop Santhanam, Bnagalore (IN); Chandramouli Vishwadutta Jamadagni, Bnagalore (IN); Sankarshana Seshagiri, Bangalore (IN)

(21) Appl. No.: 13/974,082

(22) Filed: Aug. 23, 2013

(30) Foreign Application Priority Data
Aug. 27, 2012 (IN) 3539/CHE/2012

(51) Int. Cl. H04L 29/06

(52) U.S. Cl. CPC H04L 29/06047
USPC 709/203

(57) ABSTRACT

An aspect of the present disclosure enables a service provider to facilitate access to desired services. In an embodiment, a user specifies information representing a set of services and a set of portions of a web page, wherein each service is specified associated with a corresponding portion of the set of portions. A server system then sends a web page definition to the user, with the web page definition being designed to be displayed on a client system with a layout containing the set of portions and each service being accessible in a corresponding portion. The web page definition is designed such that all user interactions via the corresponding displayed web page are routed via the server system. In addition, the responses are displayed in the same web page using partial page refresh type techniques such that the web page continues to be displayed with a same Uniform Resource Locator (URL) in duration said user interacts with said web page and also when the responses are displayed.

### RELATED APPLICATIONS

The present application is related to and claims priority from the co-pending India Patent Application entitled, “Multi-Networking Site”, Serial Number: 3539/CHE/2012, Filed: 27 Aug. 2012, naming the same inventors as in the subject patent application.

### BACKGROUND OF THE DISCLOSURE

1. Technical Field

The present disclosure relates to web based technologies, and more specifically to facilitating access of diverse web-based services.

2. Related Art

A web-based service refers to any service that can be accessed from a browser implemented on a client system. Examples of services include those that provide web pages, video, games, multi-media content, etc, as is well known in the relevant arts. Each web-based service is typically identified by a corresponding Uniform Resource Locator (URL), as is also well known in the relevant arts. The services accessible on the web are said to be divergent in view of the different types of content and applications accessible via the browser.

Service providers often wish to facilitate access of diverse web based services. Aspects of the present disclosure enable service providers to achieve such an objective.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present disclosure can be implemented.

FIG. 2 is a flow chart illustrating the manner in which service provider-facilitates access of diverse web based services

FIG. 3 depicts a predefined web page layout provided by server system 150

FIG. 4 depicts records in a table of database representing services available

FIG. 5 depicts records in a table of database representing default services associated with display portion of predefined layouts

FIGS. 6A and 7A depicts records in a table of database representing layout configuration information for a user.

FIGS. 6B and 7B depicts a web page layout and its association with services

FIGS. 6C, 7C and 7D depicts graphical user interface screen rendered as per the layout configurations.

FIG. 8 depicts portions of the source code corresponding to the web page definition sent from server system 150

FIG. 9 is a block diagram illustrating the details of server system in an embodiment.

FIG. 10 is a block diagram illustrating the details of a digital processing system in which several aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure enables a service provider to facilitate access to desired services. In an embodiment, a user specifies information representing a set of services and a set of portions of a web page, wherein each service is specified associated with a corresponding portion of the set of portions. A server system then sends a web page definition to the user, with the web page definition being designed to be displayed on a client system with a layout containing the set of portions and each service being accessible in a corresponding portion.

The web page definition is designed such that all user interactions via the corresponding displayed web page are routed via the server system. In addition, the responses are displayed in the same web page using partial page refresh type techniques such that the web page continues to be displayed with a same Uniform Resource Locator (URL) in duration said user interacts with said web page and also when the responses are displayed.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

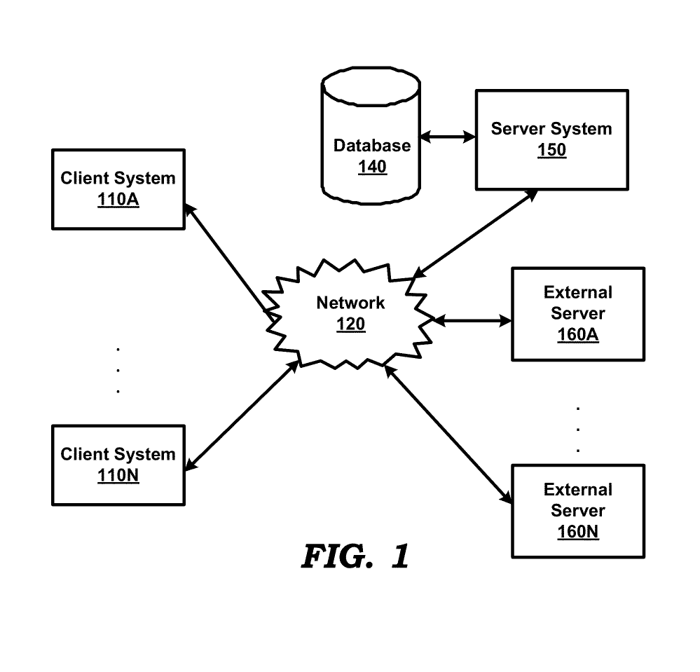

FIG. 1 is a block diagram illustrating an example environment (computing system) in which several aspects of the present disclosure can be implemented. The block diagram is shown containing client systems 110A-110N, network 120, database 140, server system 150, and external servers 160A-160N. Each block of FIG. 1 is described below in further detail.

Merely for illustration, only representative number/type of systems is shown in FIG. 1. Many environments often contain many more systems, both in number and type, depending on the purpose for which the environment is designed. Each block of FIG. 1 is described below in further detail.

Network 120 provides connectivity between the servers/systems of FIG. 1. Network 120 may be implemented using protocols such as Transmission Control Protocol (TCP) and/or Internet Protocol (IP), well known in the relevant arts. In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by network 120.

External servers 160A-160N provide various services accessible via network 120. As noted above, examples of resources provided by such services include web pages, videos, multi-media content, applications, games, etc. According to aspects of the present disclosure such accessible via server system 150, though also accessible (and accessed) directly via network 120 by client systems 110A-110N. Database 140 contains non-volatile storage for storing and retrieval of data. In an embodiment, database 140 is implemented as a relational database supporting SQL queries for such storage and retrieval of data.

Each of client systems 110A-110N enables users to access services available via network 120 using a browser. The browser may communicate with server system 150 using Hypertext Transfer Protocol (HTTP) type protocols, and may correspond to software products such as Internet Explorer, Firefox, Chrome, etc., well known in the relevant arts.

Server system 150 serves web pages to various client systems over network 120. In one prior approach, a user at a client system may be required to access each service from a different web page, and thus multiple browser instances (e.g., in the form of windows/tabs) may be required to access corresponding number of services.

Server system 150 provided according to aspects of the present disclosure enables a service provider to facilitate access of multiple services from a single web page, as described below in further detail.

Facilitating Access to Diverse Services

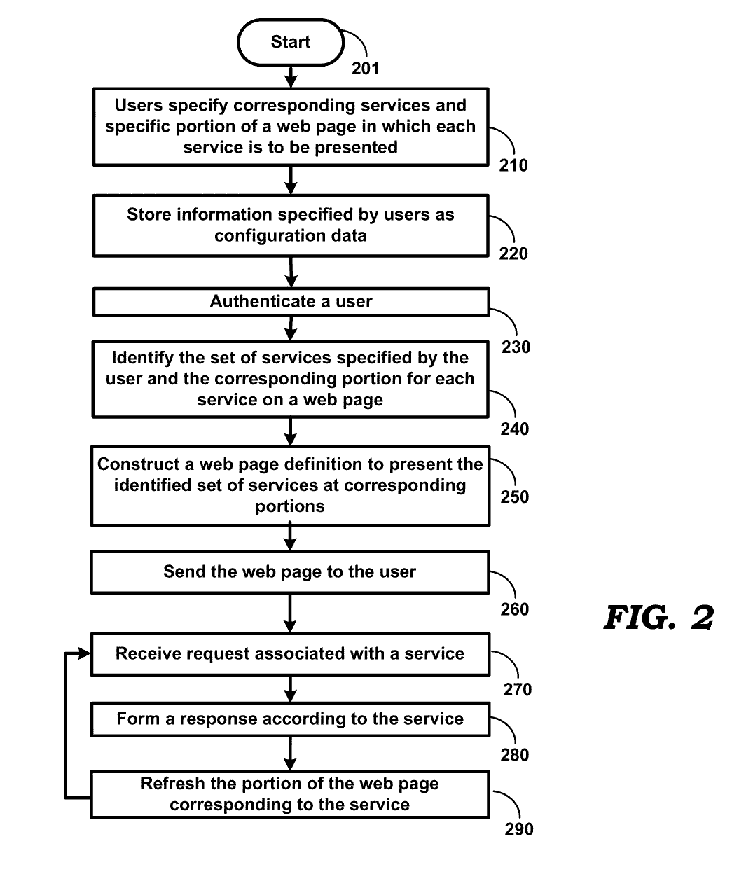

FIG. 2 is a flow chart illustrating the manner in which users are facilitated to access services from client systems, in one embodiment. The steps of the flowchart are described with respect to the specific systems of FIG. 1 merely for illustration. However, the features can be implemented in other systems and environments also without departing from the scope and spirit of several aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 210, server system 150 enables each user specify corresponding services of interest and specific portion of a web page in which each service is to be presented. Thus, different users can specify different service sets as being of interest. Similarly, each user can customize in which portion of a web page each service is presented.

In step 220, server system 150 stores information specified by users as configuration data. The information may be stored in database 140.

In step 230, server system 150 authenticates a user accessing from a client system (e.g., 110A). Though the flow chart is described for a single user, steps 230-290 can be performed for each user.

In step 240, server system 150 identifies the set of services specified by the user and the corresponding portion for each service on a web page, for example, by examining the configuration data stored in database 140. The data may be retrieved by issuing the appropriate SQL statements.

In step 250, server system 150 constructs a web page definition to present the identified set of services at corresponding portions. The web page for each user may be constructed soon after the user specifies the preferences in step 210.

In step 260, server system 150 sends the web page definition to client system 110A. The web page is constructed such that the interaction with each service at client system 110A is again routed to server system 150. Thus, the URLs specified in the web page for each service, may accordingly specify a location within server system.

In step 270, server system 150 receives a request associated with a service, in the form of the encoded URL.

In step 280, server system 150 forms a response according to the service. The response may be formed based on the information available within server system 150, or external server (e.g., external server 160A) may be accessed to form the response.

In step 290, server system 150 refreshes the portion of the web page corresponding to the service. The refresh may be caused using techniques such as redirection, in which case external server sends packets directed to client system 110A. Alternatively, server system 150 receives such packets and sends the packets to refresh the web page. Control then passes to step 270 to process the next request.

It may be appreciated that the user at client system 110A uses a single web page (identified by the corresponding unique URL), which does not change, as the user accesses the different services. Such a feature is particularly useful as the display screens get bigger in size at desktop computers, etc. The features are illustrated below with additional examples.

### 3. Example Illustration

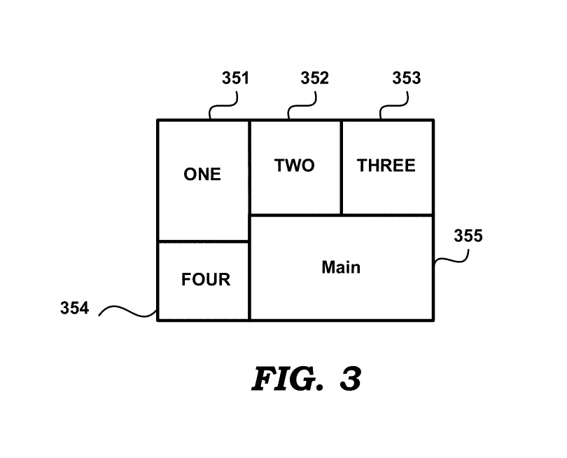

FIG. 3 depicts a web page layout shown logically divided into 5 portions. It may be appreciated that multiple such layouts may be presented and a user may be required to select one of the layouts. Alternative embodiments can permit users to specify different shapes of portions or different layouts.

In FIG. 3, portions 301-304 are customizable with specific desired services, while portion 305 is a main portion that remains the same for all users using the template of FIG. 3.

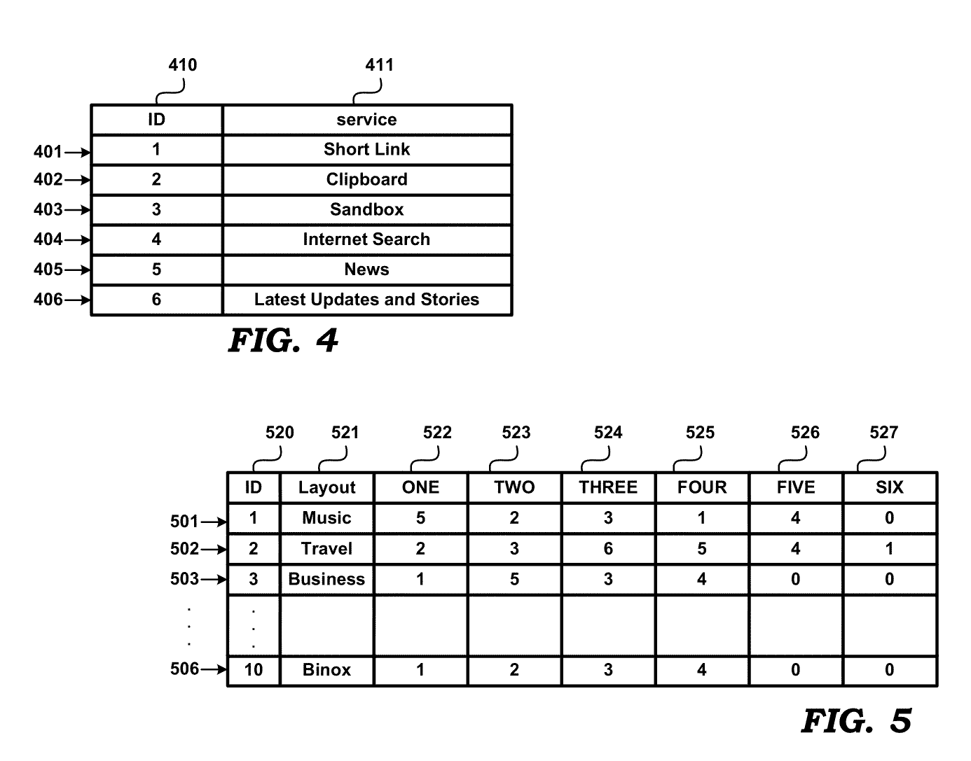

FIG. 4 depicts a table listing the services available and the corresponding short description. Each service in column 411 is shown identified by a corresponding id in column 410. Some of the services may be based on external servers, while some of the services may be provided based on operations performed exclusively (among all servers) within server system 150, as noted above.

FIG. 5 depicts a table showing multiple layouts (521) in respective rows 501-506, with the number in columns 522-527 specifying the value in ID 410 to specify a corresponding service. A value of 0 indicates no service is to be used.

Thus, for business in row 503 (corresponding to the layout of FIG. 3), the four portions are shown with default services short link (1), new (5), sandbox (3) and internet search (4), which can be further customized by each user.

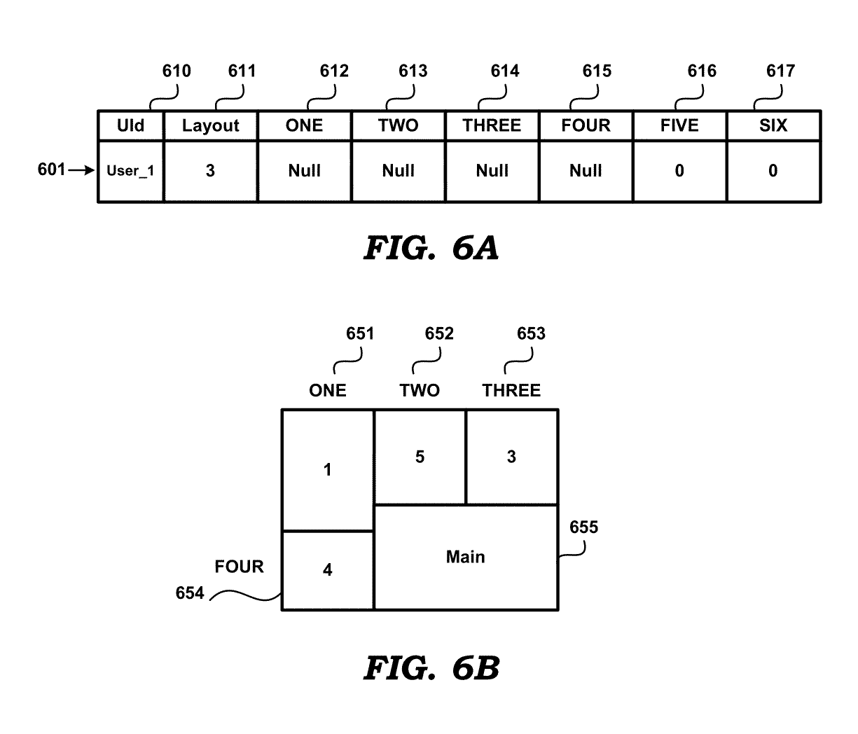

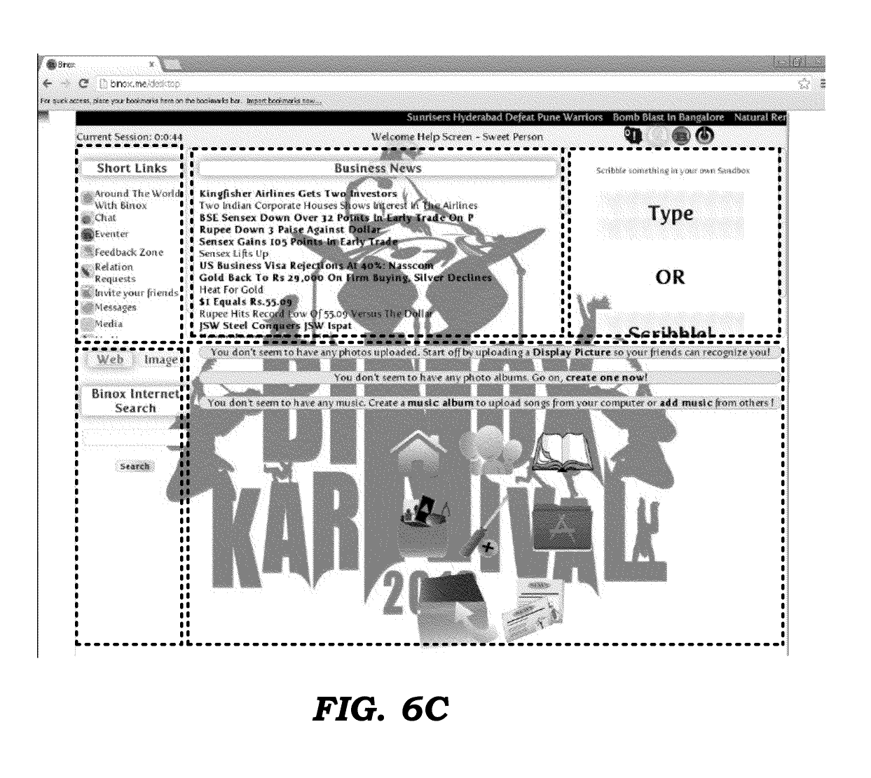

FIG. 6A depicts another table representing the configuration data stored upon performance of step 210 for a user. The user is assumed to have accepted the ‘business layout’ (layout id 3) option (column 611), and not performed any customizations as depicted by NULL in columns 612-617, making row 503 operative as the basis operative layout, as depicted in FIG. 6B logically. In the boxes 651-654, the numbers 1, 5, 3 and 4 represent the service identified in column 410.

FIG. 6C depicts a web page displayed on client system 110A, corresponding to the layout specified by/for the user in row 601 (after the user is authenticated). The corresponding web page definition constructed and sent from server system 150 is listed as Appendix A. As may be observed, the layout of services on the web page matches that in FIG. 6B.

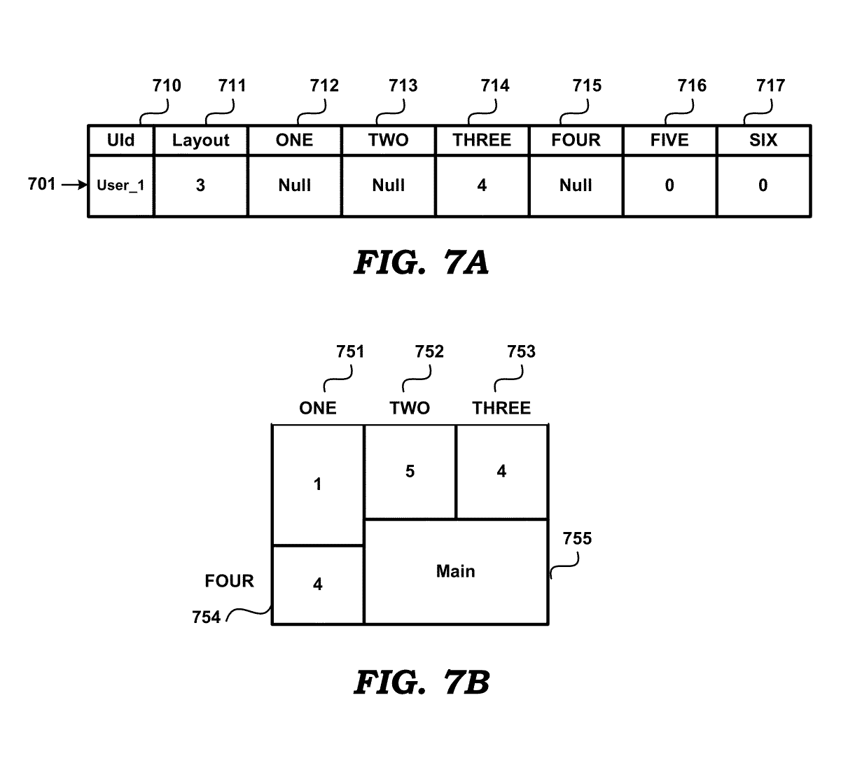

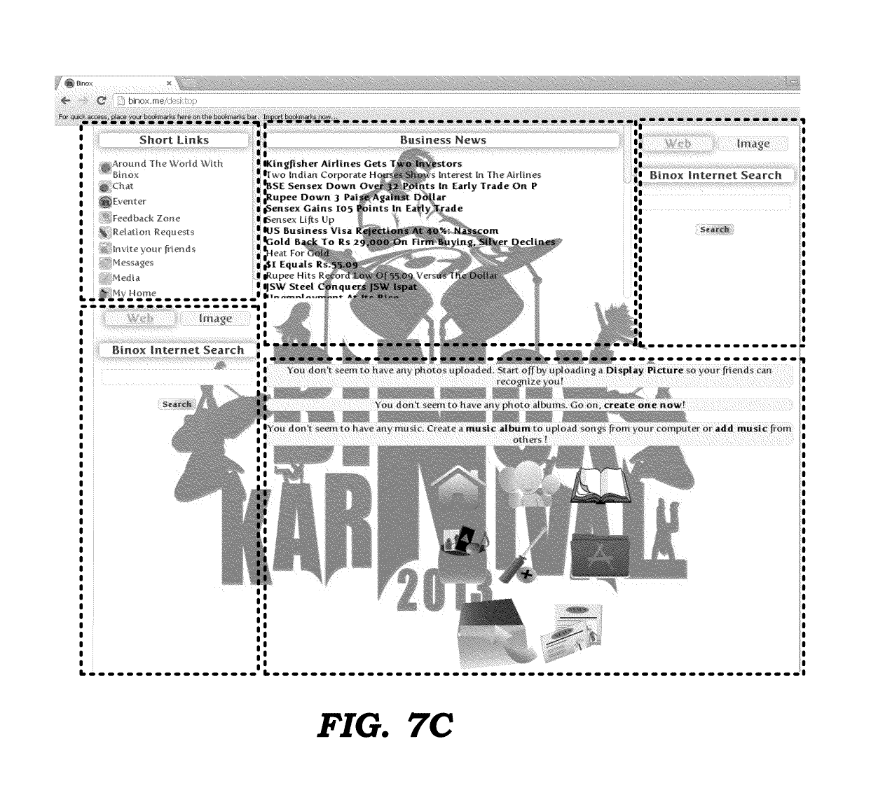

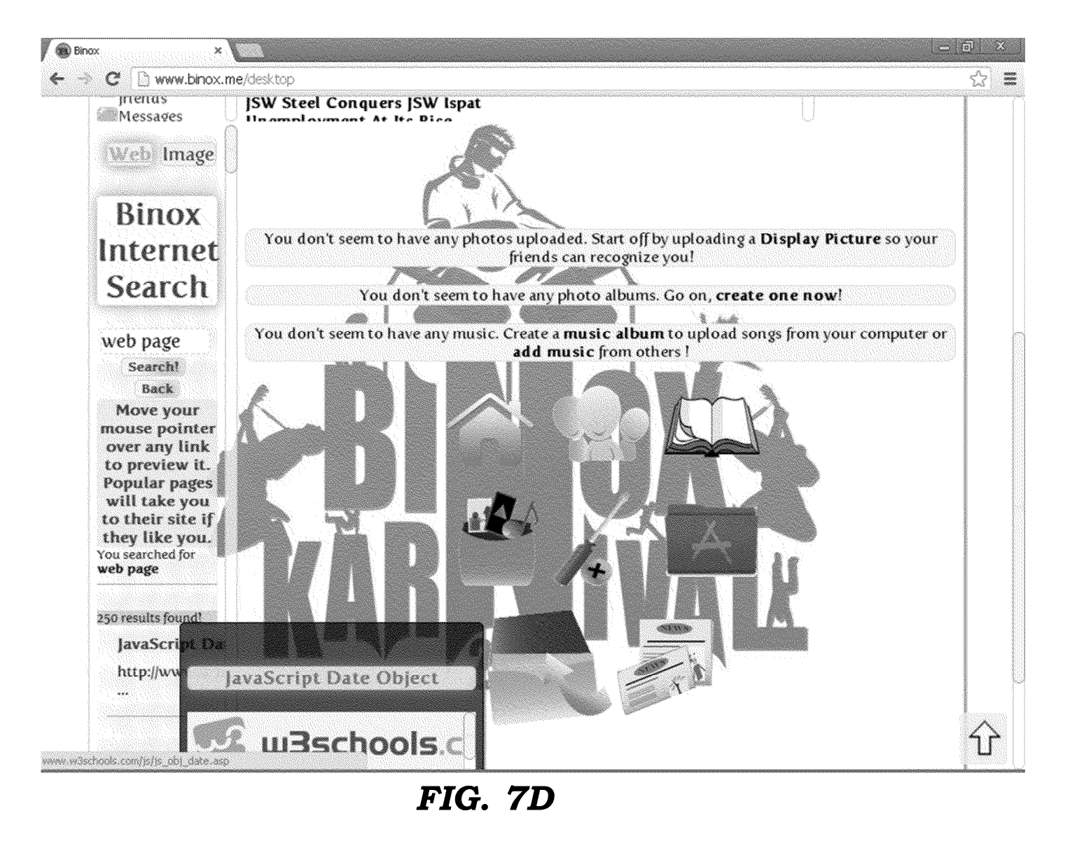

FIG. 7A depicts the changes to table of FIG. 6A after a user customizes the layout to specify service 4 (Internet search) in portion THREE. The corresponding logical layout is shown in FIG. 7B, with portion 754 depicting the changed service. The corresponding web page is depicted in FIG. 7C, showing the search tool in two portions. The corresponding web page definition constructed and sent from server system 150 is listed as Appendix B.

As may be observed, the URL (binox.me/desktop) is shown remaining the same in both FIGS. 6C and 7C. The URL continues to be the same as the user interacts with the services in different portions, as illustrated with respect to FIG. 7D as well. In particular, a user requesting a search for ‘web page’ in portion FOUR, and the results are shown depicted in the same portion in FIG. 7D. However, the URL, as well as other portions, are shown unchanged. The HTML content served to cause the refresh of FIG. 7D is shown in Appendix C.

To ensure that the other portions are unchanged, technologies such as frames/AJAX may be employed, as would be apparent to one skilled in the relevant arts by reading the disclosure provided herein.

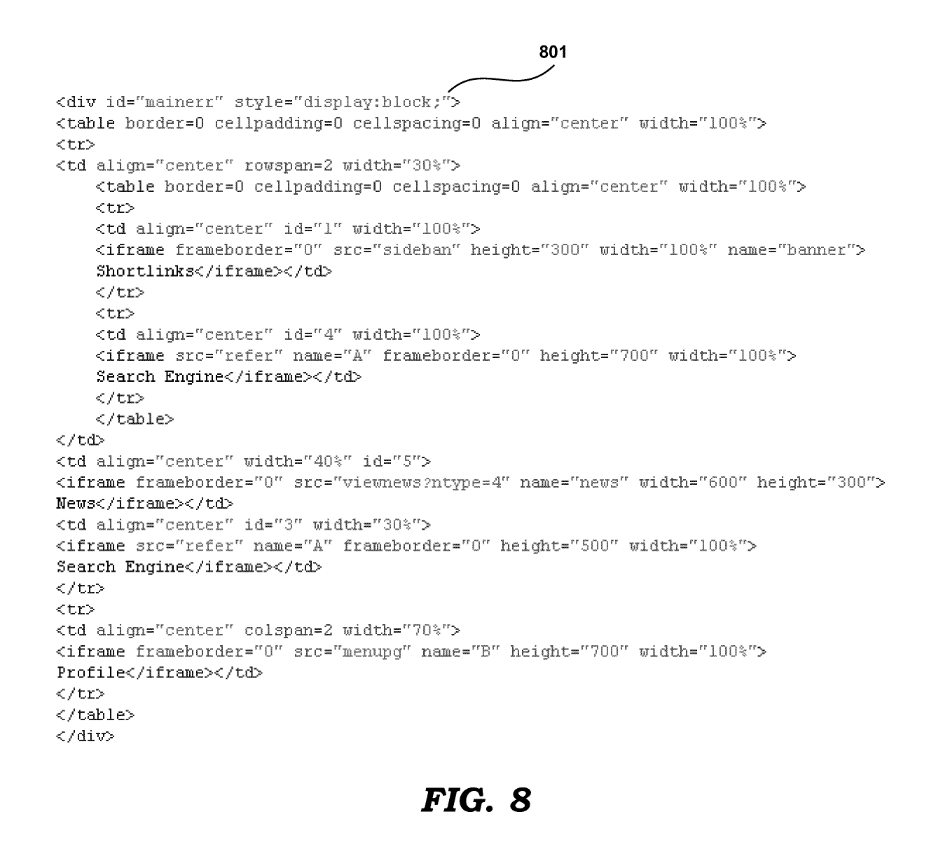

FIG. 8 depicts some of the portions of the source code (from Appendix B) corresponding to the web page definition sent from server system 150 to client system 110A. Section 801 shows that a URL (‘viewnews?ntype=4’) corresponding to a location within server system 150, implying that the user interactions result in packets being transmitted to server system 150. URL at 801 is a relative URL and it refers to a service within server system 150. The URL is examined by server system 150 to determine the specific resource/transaction (URL at 801 refers to News service) being requested, and serves the corresponding content in the portion of the web page.

The description is continued with respect to example implementations of server system 150.

### 4. Server System

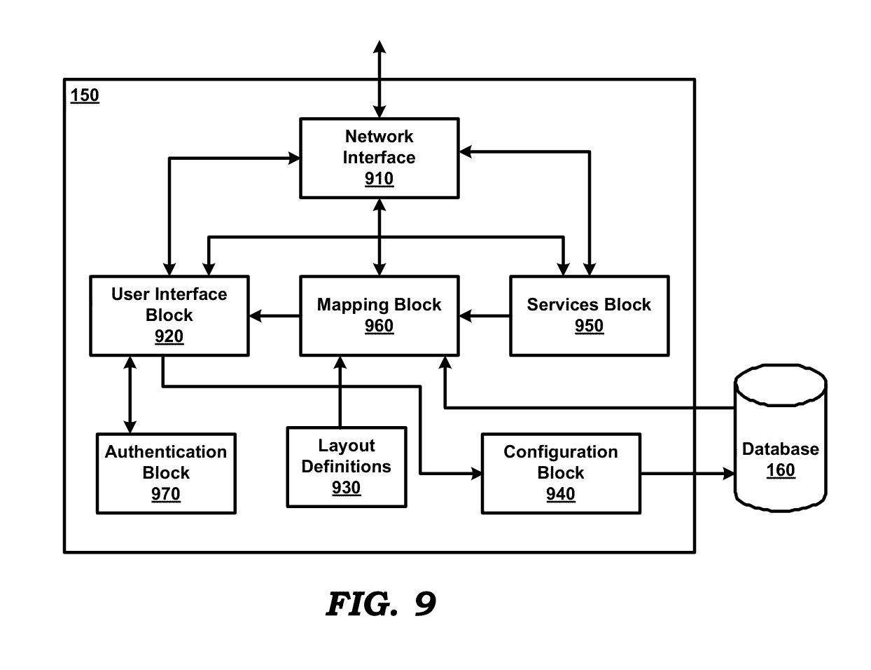

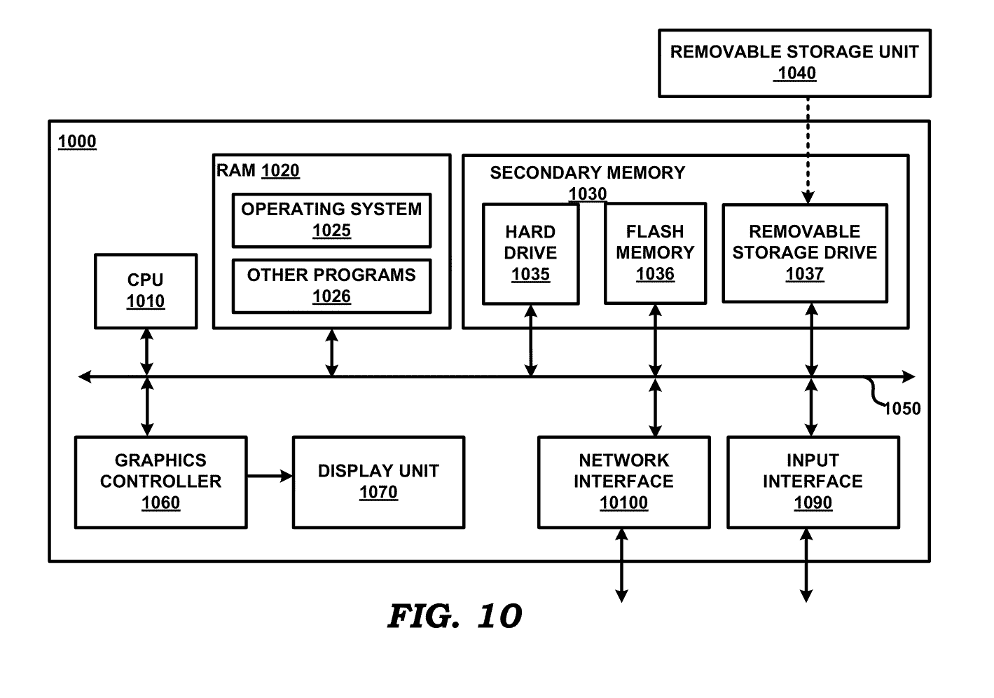

FIG. 9 is a block diagram illustrating the details of server system 150 in an embodiment. Server system 150 is shown containing network interface 910, user interface block 920, layout definitions 930, configuration block 940, services block 950, mapping block 960 and authentication block 970.

Network interface 910 provides electrical and protocol interfaces (e.g., network cards, network protocol stacks, etc.) to enable various blocks of server system 150 to communicate via network 120. In general, packets directed to server system 150 are examined for forwarding to the appropriate internal block/application. Similarly, network interface 910 sends packets directed to other external systems (upon receipt of the corresponding packets from the respective block). Network interface 910 may be implemented in a known way.

User interface block 920 provides a convenient user interface using which users may interact with server system 150. User interface block 920 receives requests from client system and depending on the request, it propagates it further to one of the blocks of server system 150. User interface block 920 may be implemented based on various web server products such as Apache, IIS, etc., servers, available in the marketplace. In general, the block serves HTML web pages to client systems 110A-110N.

Authentication block 970 authenticates users before permitting configuration of desired services/layout of the web page. In case of new user, authentication block enables new user to register with the server system. In current embodiment, user is authenticated using user id and password. Authenticated user can access web pages provided by server system 150.

Layout definitions 930 represent the templates in HTML for each layout. For example, the template of FIG. 3 may be represented by one of such definitions, and 6 layouts corresponding to FIG. 5 may be contained in layout definitions 930.

Configuration block 940 enables users to perform step 210 noted above (after corresponding authentication). The information received from each user (including selection of one of the templates of FIG. 5, and any further customizations as described above with respect to FIG. 7A) is stored in database 160. Any suitable user interfaces (e.g., GUI) may be provided to enable user to perform such configurations.

Mapping block 960 is operative upon authentication of a user (having configuration complete), and identifies the layout for the user and the services to be provided within each portion of the layout, by examining the tables in database 160. The corresponding layout is retrieved from layout definitions block 930, the URLs corresponding to the user specified URLs are embedded in the appropriate portions of the web page (to construct the page definition). The construction of the web page definition will be apparent to a skilled practitioner, by reading the disclosure provided herein.

Services block 950 receives requests as a user interacts with different portions of the web page, and generates the corresponding responses. For example, a request may be received (corresponding to URL at 801) when a user interacts with News in portion 2 of FIG. 6C. Services block 950 generates content representing the response, and is provided for refreshing in the corresponding portion.

It may be appreciated that each request generated at the corresponding web page portion is received by services block (since all URLs in the web page) since all the URLs in the web page definition are internal URLs (as opposed to external URLs which refer directly to the external servers 160A/160B). Services block 950 may execute the appropriate internal routines to generate the response for the requests.

Alternatively, as noted above, services block 950 may be interface with external servers to retrieve/form the content. Services block 950 may invoke the services at the external servers using a globally unique URL that identifies the corresponding service. Service block 950 accordingly maintains a mapping table that indicates whether a locally implemented service/routine needs to be executed, or the corresponding global URL to use for generating the content corresponding to the response. The implementation of service lock 950 will be apparent to one skilled in the relevant arts by reading the disclosure provided herein.

It should be further appreciated that the features described above can be implemented in various embodiments as a desired combination of one or more of hardware, software, and firmware. The description is continued with respect to an embodiment in which various features are operative when the software instructions described above are executed.

### 5. Digital Processing System

FIG. 10 is a block diagram illustrating the details of digital processing system 1000 in which various aspects of the present disclosure are operative by execution of appropriate software instructions. Digital processing system 1000 may correspond to server system 150 or client system 110A.

Digital processing system 1000 may contain one or more processors such as a central processing unit (CPU) 1010, random access memory (RAM) 1020, secondary memory 1030, graphics controller 1060, display unit 1070, network interface 1080, and input interface 1090. All the components except display unit 1070 may communicate with each other over communication path 1050, which may contain several buses as is well known in the relevant arts. The components of FIG. 10 are described below in further detail.

CPU 1010 may execute instructions stored in RAM 1020 to provide several features of the present disclosure. CPU 1010 may contain multiple processing units, with each processing unit potentially being designed for a specific task. Alternatively, CPU 1010 may contain only a single general-purpose processing unit.

RAM 1020 may receive instructions from secondary memory 1030 using communication path 1050. RAM 1020 is shown currently containing software instructions constituting shared environment 1025 (e.g., network interface 910 and user interface block 920 in case of server system 150) and/or user programs 1026 (such as Web browser in case of client system 110A, and). Shared environment 1025 includes operating systems, device drivers, virtual machines, etc., which provide a (common) run time environment for execution of user programs 1026.

Graphics controller 1060 generates display signals (e.g., in RGB format) to display unit 1070 based on data/instructions received from CPU 1010. Display unit 1070 contains a display screen to display the images defined by the display signals. Input interface 1090 may correspond to a keyboard and a pointing device (e.g., touch-pad, mouse) and may be used to provide inputs. Network interface 1080 provides connectivity to a network (e.g., using Internet Protocol), and may be used to communicate with other systems (such as those shown in FIG. 1) connected to the network.

Secondary memory 1030 may contain hard drive 1035, flash memory 1036, and removable storage drive 1037. Secondary memory 1030 may store the data software instructions (e.g., for performing the actions noted above with respect to FIG. 2), which enable digital processing system 1000 to provide several features in accordance with the present disclosure.

Some or all of the data and instructions may be provided on removable storage unit 1040, and the data and instructions may be read and provided by removable storage drive 1037 to CPU 1010. Floppy drive, magnetic tape drive, CD-ROM drive, DVD Drive, Flash memory, removable memory chip (PCMCIA Card, EEPROM) are examples of such removable storage drive 1037.

Removable storage unit 1040 may be implemented using medium and storage format compatible with removable storage drive 1037 such that removable storage drive 1037 can read the data and instructions. Thus, removable storage unit 1040 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 1040 or hard disk installed in hard drive 1035. These computer program products are means for providing software to digital processing system 1000. CPU 1010 may retrieve the software instructions, and execute the instructions to provide various features of the present disclosure described above.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 11. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

```
Appendix A
1. Html content served by server system for web page layout:
<!DOCTYPE html>
  <html>
  <head>
  <meta charset=“utf-8”>
  <title>Binox</title>
  .
  .
  .
  <div id=“mainerr” style=“display:block;”>
  <table border=0 cellpadding=0 cellspacing=0 align=“center” width=“100%”>
  <tr>
  <td align=“center” rowspan=2 width=“30%”>
    <table border=0 cellpadding=0 cellspacing=0 align=“center” width=“100%”>
    <tr>
    <td align=“center” id=“1” width=“100%”>
    <iframe frameborder=“0” src=“sideban” height=“300” width=“100%” name=“banner”>
    Shortlinks</iframe></td>
    </tr>
    <tr>
    <td align=“center” id=“4” width=“100%”>
    <iframe src=“refer” name=“A” frameborder=“0” height=“700” width=“100%”>
    Search Engine</iframe></td>
    </tr>
    </table>
  </td>
  <td align=“center” width=“40%” id=“5”>
  <iframe frameborder=“0” src=“viewnews?ntype=4” name=“news” width=“600”height=“300”>
  News</iframe></td>
  <td align=“center” id=“3” width=“30%”>
<iframe src=“sboxw?id=sweetperson110@gmail.com&whr=0” name=“ban” frameborder=“0” height=“500”
width=“100%”>Sandbox</iframe></td>
  </tr>
  <tr>
  <td align=“center” colspan=2 width=“70%”>
  <iframe frameborder=“0” src=“menupg” name=“B” height=“700” width=“100%”>
  Profile</iframe></td>
  </tr>
  </table>
  </div>
.
  .
  .
</html>
2. Html content served by server system for Main portion of the web page:
<!DOCTYPE html>
<html>
<head>
<title>Main Menu / Binox</title>
.
  .
  .
<div align=“center” style=“background-color:#FFFFAA;border:1px solid #FFFF00;-webkit-border-radius:10px;-moz-border-
radius:10px;border-radius:10px;”>You don't seem to have any music. Create a <b><a
href=“albcreate?chng=YtOHjUiM9UjLgDrF687HnJm” onmouseover=“tooleron(event,‘Create a music album’)”
onmouseout=“tooleroff( )” target=“B”>music album</a></b> to upload songs from your computer or <b><a
href=“music?id=sweetperson110@gmail.com” onmouseover=“tooleron(event,‘Search and add music from others’)”
onmouseout=“tooleroff( )” target=“B”>add music</a></b> from others !</div>
.
  .
  .
</html>
3. Html content served by server system for Internet search service:
<!DOCTYPE html>
<html>
<head>
<meta charset=“utf-8”>
<title>Binox Internet Search Engine</title>
.
  .
  .
<div align=“center”><h3 class=“heads” align=“center”>Binox <font id=“head”>Internet</font> Search</h3><input
type=‘text’ style=“width:95%” class=“txt” name=‘search’ onmouseover=“tooleron(event,‘Enter some text to
search’)” onmouseout=“tooleroff( )”></br></br>
<input type=‘submit’ name=‘submit’ class=“updatebutton” value=‘Search’></br></br>
</div>
<div id=“hold”></div>
</form>
<div align=“center”><!--<iframe src=“adpax.php?paxtype=2” frameborder=“0” name=“ad2” width=“100%”
height=“500”></iframe>--></div>
<div id=“tooltip”></div>
</body>
</html>
4. Html content served by server system for Sandbox service
<!DOCTYPE html>
<html>
<head>
<meta http-equiv=“Content-Type” content=“text/html; charset=iso-8859-1”>
<title>Sweet Person's Sandbox</title>
.
  .
  .
<table border=0 cellpadding=0 cellspacing=10 align=“center” width=“95%”>
<tr>
<td align=“left” colspan=2 style=“font-size:smaller;color:#333333;”>Scribble something in your own Sandbox</td>
.
  .
  .
</body>
</html>
5. Html content served by server system for Short Link service
<!DOCTYPE html>
<html>
<head>
<meta charset=“utf-8”>
<title>Short Links</title>
.
  .
  .
<h3 align=“center” class=“heads”>Short Links</h3>
<table align=“left” border=0 cellpadding=0 cellspacing=0 class=“shltabl”>
<tr>
<td align=“center” rowspan=2 class=“menu”><img src=“pix/slatwwb1.jpg” border=0 alt=“ATWWB”></td>
<td align=“left” width=500 class=“menu”><a href=“javascript:void(0)” onmouseover=“tooleron(event,‘Around The
World With Binox’)” onmouseout=“tooleroff( )” onClick=“showw(‘atwwb’)” class=“menu”>Around The World With
Binox</a>&amp;nbsp;&amp;nbsp;<a id=“newsno” class=“notifb”></a></td>
</tr>
.
  .
  .
</body>
</html>
6. Html content served by server system for News service
<!DOCTYPE html>
<html>
<head>
<meta http-equiv=“Content-Type” content=“text/html; charset=iso-8859-1”>
<title>Settings</title>
.
  .
  .
<tr>
<td align=“left”>Increase In Price Of Tickets Duel To Increase In Price Of Diesel</td>
</tr>
</table></div></body>
</html>
Appendix B
7. Html content served by server system for web page layout:
<!DOCTYPE html>
  <html>
  <head>
  <meta charset=“utf-8”>
  <title>Binox</title>
  .
  .
  .
  <div id=“mainerr” style=“display:block;”>
  <table border=0 cellpadding=0 cellspacing=0 align=“center” width=“100%”>
  <tr>
  <td align=“center” rowspan=2 width=“30%”>
    <table border=0 cellpadding=0 cellspacing=0 align=“center” width=“100%”>
    <tr>
    <td align=“center” id=“1” width=“100%”>
    <iframe frameborder=“0” src=“sideban” height=“300” width=“100%” name=“banner”>
    Shortlinks</iframe></td>
    </tr>
    <tr>
    <td align=“center” id=“4” width=“100%”>
    <iframe src=“refer” name=“A” frameborder=“0” height=“700” width=“100%”>
    Search Engine</iframe></td>
    </tr>
    </table>
  </td>
  <td align=“center” width=“40%” id=“5”>
  <iframe frameborder=“0” src=“viewnews?ntype=4” name=“news” width=“600” height=“300”>
  News</iframe></td>
  <td align=“center” id=“3” width=“30%”>
  <iframe src=“refer” name=“A” frameborder=“0” height=“500” width=“100%”>
  Search Engine</iframe></td>
  </tr>
  <tr>
  <td align=“center” colspan=2 width=“70%”>
  <iframe frameborder=“0” src=“menupg” name=“B” height=“700” width=“100%”>
  Profile</iframe></td>
  </tr>
  </table>
  </div>
.
  .
  .
</html>
8. Html content served by server system for Main portion of the web page:
<!DOCTYPE html>
<html>
<head>
<title>Main Menu / Binox</title>
.
  .
  .
<div align=“center” style=“background-color:#FFFFAA;border:1px solid #FFFF00;-webkit-border-radius:10px;-moz-border-
radius:10px;border-radius:10px;”>You don't seem to have any music. Create a <b><a
href=“albcreate?chng=YtOHjUiM9UjLgDrF687HnJm” onmouseover=“tooleron(event,‘Create a music album’)”
onmouseout=“tooleroff( )” target=“B”>music album</a></b> to upload songs from your computer or <b><a
href=“music?id=sweetperson110@gmail.com” onmouseover=“tooleron(event,‘Search and add music from others’)”
onmouseout=“tooleroff( )” target=“B”>add music</a></b> from others !</div>
.
  .
  .
</html>
9. Html content served by server system for Internet search service:
<!DOCTYPE html>
<html>
<head>
<meta charset=“utf-8”>
<title>Binox Internet Search Engine</title>
.
  .
  .
<div align=“center”><h3 class=“heads” align=“center”>Binox <font id=“head”>Internet</font> Search</h3><input
type=‘text’ style=“width:95%” class=“txt” name=‘search’ onmouseover=“tooleron(event,‘Enter some text to
search’)” onmouseout=“tooleroff( )”></br></br>
<input type=‘submit’ name=‘submit’ class=“updatebutton” value=‘Search’></br></br>
</div>
<div id=“hold”></div>
</form>
<div align=“center”><!--<iframe src=“adpax.php?paxtype=2” frameborder=“0” name=“ad2” width=“100%”
height=“500”></iframe>--></div>
<div id=“tooltip”></div>
</body>
</html>
10. Html content served by server system for Short Link service:
<!DOCTYPE html>
<html>
<head>
<meta charset=“utf-8”>
<title>Short Links</title>
.
  .
  .
<h3 align=“center” class=“heads”>Short Links</h3>
<table align=“left” border=0 cellpadding=0 cellspacing=0 class=“shltabl”>
<tr>
<td align=“center” rowspan=2 class=“menu”><img src=“pix/slatwwb1.jpg” border=0 alt=“ATWWB”></td>
<td align=“left” width=500 class=“menu”><a href=“javascript:void(0)” onmouseover=“tooleron(event,‘Around The
World With Binox’)” onmouseout=“tooleroff( )” onClick=“showw(‘atwwb’)” class=“menu”>Around The World
With Binox</a>&amp;nbsp;&amp;nbsp;<a id=“newsno” class=“notifb”></a></td>
</tr>
.
  .
  .
</body>
</html>
11. Html content served by server system for News service
<!DOCTYPE html>
<html>
<head>
<meta http-equiv=“Content-Type” content=“text/html; charset=iso-8859-1”>
<title>Settings</title>
.
  .
  .
<tr>
<td align=“left”>Increase In Price Of Tickets Duel To Increase In Price Of Diesel</td>
</tr>
</table></div></body>
  </html>
Appendix C
12. Html content served by server system for Internet search service with search results:
<!DOCTYPE html>
<html>
<head>
<meta charset=“utf-8”>
<title>Binox Internet Search</title>
.
.
.
<div align=“center” class=“contmain”>Move your mouse pointer over any link to preview it. Popular pages will take
you to their site if they like you. </div>
<div id=“res”>
<div align=‘left’ style=‘color:#000000;font-family:Fertigo, Verdana, Arial, Helvetica, sans-serif;font-
size:smaller;’>You searched for <b>web page</b></div><hr size=‘1’><br><div align=‘left’ style=‘background-
color:#CCCCCC;color:#000000;font-family:Fertigo, Verdana,Arial, Helvetica, sans-serif;font-size:smaller;’>250
results found!</div><div align>“center”><table border=0 cellpadding=0 cellspacing=10 align=“center”
width=“80%”>
<tr>
<td align=“center” rowspan=2><!--<a href=“http://www.w3schools.com/js/js_obj_date.asp” target=“_blank”
class=“results” onClick=“hiturl(2470,1)”><img src=““ border=0 alt=“Image”></a>--></td>
<td align=“left”><b><a href=“http://www.w3schools.com/js/js_obj_date.asp” title=““ target=“_blank”
class=“results” onmouseover=“urlget(event,‘http://www.w3schools.com/js/js_obj_date.asp’)”
onmouseout=“tooleroff( )” onClick=“hiturl(2470,1)”>JavaScript Date Object</a></b></td>
.
.
.
</tr>
</table>
</body>
</html>
```

What is claimed is:

1. A method of enabling access to desired services, said method being performed in a server system operable in conjunction with a client system, said method comprising:
enabling a user to specify information representing a set of services and a set of portions of a web page, wherein each service is specified associated with a corresponding portion of said set of portions;
storing said information in a memory;
sending a web page definition, said web page definition being designed to be displayed on said client system with a layout containing said set of portions and each of said set of services being accessible in a corresponding portion of said set of portions;
receiving a sequence of requests as a user interacts with said set of services in corresponding portions on said client system;
forming content representing a sequence of responses, each response corresponding to a request of said sequence of requests; and
sending said sequence of responses to said client system,
wherein the content of each response is displayed in a same portion in which the corresponding request originated,
wherein said web page is displayed with a same Uniform Resource Locator (URL) in a duration said user interacts with said web page and also when said sequence of responses are displayed.

2. The method of claim 1, wherein said sequence of requests comprise a first request, and said sequence of responses comprise a first response corresponding to said first request,
the content for said first response being generated by an external server.

3. The method of claim 2, wherein said sequence of requests comprise a second request, and said sequence of responses comprise a second response corresponding to said second request,
the content for said second response being generated by said server system.
